(19) United States
(12) Patent Application Publication
(10) Pub. No.: US 2026/0230842 A1
(43) Pub. Date: Aug. 6, 2026

(54) METHODS TO SUPPORT MEASUREMENT GAP CONFIGURATION FOR DATA COLLECTION

(71) Applicant: InterDigital Patent Holdings, Inc., Wilmington, DE (US)

(72) Inventors: Dylan Watts, Montreal (CA); Patrick Tooher, Montreal (CA); Oumer Teyeb, Montreal (CA); Yugeswar Deenoo Narayanan Thangaraj, Chalfont, PA (US); Brian Martin, Farnham (GB); Virgil Comsa, Montreal (CA)

(73) Assignee: InterDigital Patent Holdings, Inc., Wilmington, DE (US)

(21) Appl. No.: 19/044,037

(22) Filed: Feb. 3, 2025

(51) Int. Cl. H04W 24/02; H04L 41/16; H04W 8/22

(52) U.S. Cl. CPC H04W 24/02; H04L 41/16; H04W 8/22

(57) ABSTRACT

A method may be implemented by a wireless transmit/receive unit (WTRU), including receiving a data collection configuration. The data collection configuration may include an indication of measurement resources and an identifier associated with a WTRU-side or network-side artificial intelligence/machine learning (AIML) data collection. Data collection may be performed based on the data collection configuration. It may be determined that the WTRU cannot continue to collect data in accordance with the data collection configuration. An indication that the WTRU cannot continue to collect data in accordance with the data collection configuration may be sent to a network. An indication for a measurement gap configuration may be received from the network. Data collection may resume based on the data collection configuration and in accordance with the measurement gap configuration.

### BACKGROUND

3rd Generation Partnership Project (3GPP) has recently begun integrating Artificial Intelligence/Machine Learning (AIML) into Fifth-Generation New Radio (5G NR) to enhance air-interface performance (e.g., improved throughput, robustness, accuracy, and/or reliability) and/or reduce complexity and/or overhead. Selected features, based on an assessment of their performance in comparison with traditional methods and the associated potential specification impact, may include AIML for beam management, positioning, and/or Channel State Information (CSI) prediction.

Part of the general framework needed to support these use cases may include the definition and specification of both Wireless Transmit/Receive Unit (WTRU)-side and network (NW)-side data collection. Data collection may be performed for different purposes in Life Cycle Management (LCM) (e.g., model training, model inference, model monitoring, model selection, and/or model update), each with different requirements and potential specification impact.

### SUMMARY

A wireless transmit/receive unit (WTRU) may include a processor. The processor may be configured to receive a data collection configuration. The data collection configuration may include an indication of measurement resources and an identifier associated with WTRU-side or network-side artificial intelligence or machine learning (AIML) data collection. The processor may be configured to perform data collection based on the data collection configuration, and may determine that the WTRU cannot continue to collect data in accordance with the data collection configuration. The processor may be configured to send, to a network, an indication that the WTRU cannot continue to collect data in accordance with the data collection configuration, and may receive, from the network, an indication for a measurement gap configuration. The processor may be configured to resume data collection based on the data collection configuration and in accordance with the measurement gap configuration.

The data collection configuration may include at least one of an indication of a data reporting requirement, a measurement periodicity, or a preferred measurement gap configuration.

The identifier associated with WTRU-side or network-side AIML data collection may correspond to data indicating at least one of network-side AIML model training conditions, a classification label for collected data, or a reference to a previously trained model.

The processor may be configured to determine that the WTRU cannot continue to collect data in accordance with the data collection configuration based on at least one of exceeding WTRU processing capability due to at least one of retuning time or frequency switching constraints, an invalid band combination, a measurement scheduling conflict, or conflicting configurations from multiple network entities.

The processor may be configured to determine that the WTRU cannot continue to collect data in accordance with the data collection configuration. The processor may be configured to request the measurement gap configuration from the network based on the determination that the data collection cannot continue in accordance with the data collection configuration.

The indication may include a reason data collection cannot continue, a preferred measurement gap configuration, or an indication of one or more configurations preventing the WTRU from resuming data collection. The one or more configurations preventing the WTRU from resuming data collection may include an indication of a capability limitation of the WTRU, an indication of an invalid band combination, an indication of conflicting data collection configurations, or an indication of a scheduling conflict.

The processor may be configured to receive, from a gNB, a measurement gap configuration for data collection, wherein the measurement gap configuration is determined by the gNB based on configuration information from one or more network entities, the one or more network entities comprising at least one of the gNB, an access and mobility management function (AMF), or an operations, administration, and maintenance (OAM) function.

The processor may be configured to determine that the measurement gap configuration is no longer needed based on an indication that AIML model training is complete, and may be configured to send, to the network, an indication that the data collection is complete.

The processor may be configured to receive, from the network, an indication that the measurement gap configuration is suspended and, in response, resume regular transmission and reception according to network scheduling.

The processor may be configured to temporarily suspend data collection in response to power constraints.

A method may be implemented by a wireless transmit/receive unit (WTRU), including receiving a data collection configuration. The data collection configuration may include an indication of measurement resources and an identifier associated with a WTRU-side or network-side artificial intelligence/machine learning (AIML) data collection. Data collection may be performed based on the data collection configuration. It may be determined that the WTRU cannot continue to collect data in accordance with the data collection configuration. An indication that the WTRU cannot continue to collect data in accordance with the data collection configuration may be sent to a network. An indication for a measurement gap configuration may be received from the network. Data collection may resume based on the data collection configuration and in accordance with the measurement gap configuration.

The data collection configuration may include at least one of an indication of a data reporting requirement, a measurement periodicity, or a preferred measurement gap configuration.

The identifier associated with WTRU-side or network-side AIML data collection may correspond to data indicating at least one of network-side AIML model training conditions, a classification label for collected data, or a reference to a previously trained model.

The method may include determining that the WTRU cannot continue to collect data in accordance with the data collection configuration. The determination may be based on at least one of exceeding WTRU processing capability due to at least one of retuning time or frequency switching constraints, an invalid band combination, a measurement scheduling conflict, or conflicting configurations from multiple network entities.

The method may include determining that the WTRU cannot continue to collect data in accordance with the data collection configuration, and may include requesting the measurement gap configuration from the network based on the determining that data collection cannot continue in accordance with the data collection configuration.

The indication sent to the network may include at least one of a reason data collection cannot continue, a preferred measurement gap configuration, or an indication of one or more configurations preventing the WTRU from resuming data collection, wherein the one or more configurations preventing the WTRU from resuming data collection comprise at least one of WTRU capability limitations, invalid band combinations, conflicting data collection configurations, or scheduling conflicts.

The method may include receiving, from a gNB, a measurement gap configuration for data collection, wherein the measurement gap configuration is determined by the gNB based on configuration information from one or more network entities, the one or more network entities comprising at least one of the gNB, an access and mobility management function (AMF), or an operations, administration, and maintenance (OAM) function.

The method may include determining that the measurement gap configuration is no longer needed based on an indication that AIML model training is complete, and may include sending, to the network, an indication that the data collection is complete.

The method may include receiving, from the network, an indication that the measurement gap configuration is suspended and, in response, resuming regular transmission and reception according to network scheduling.

The method may include temporarily suspending data collection in response to power constraints

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating a method to perform a measurement gap configuration for data collection by requesting, receiving, applying, and/or releasing a measurement gap configuration for AIML data collection.

### DETAILED DESCRIPTION

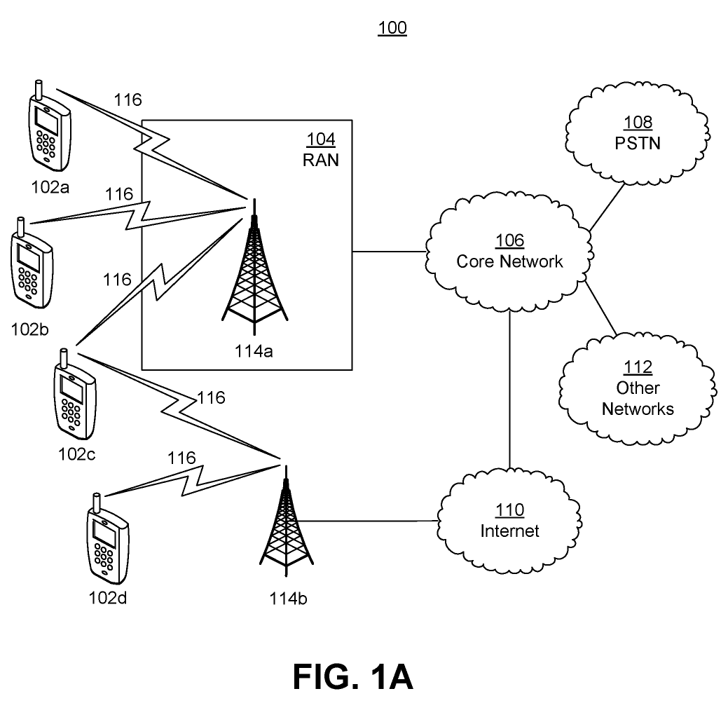

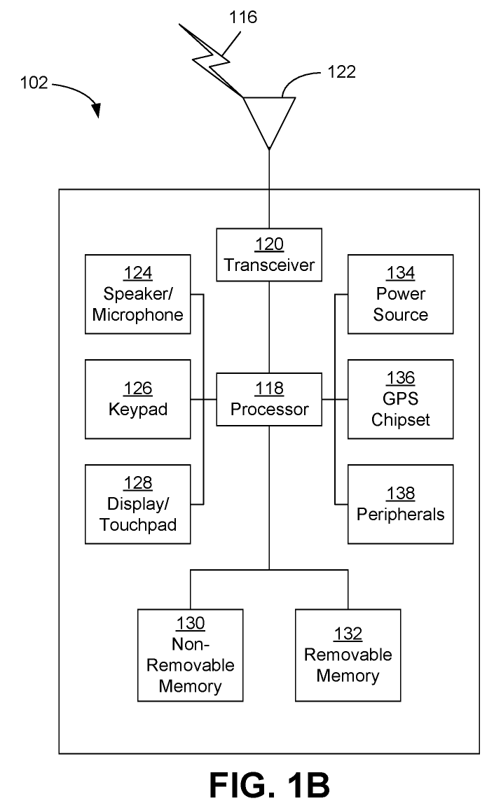

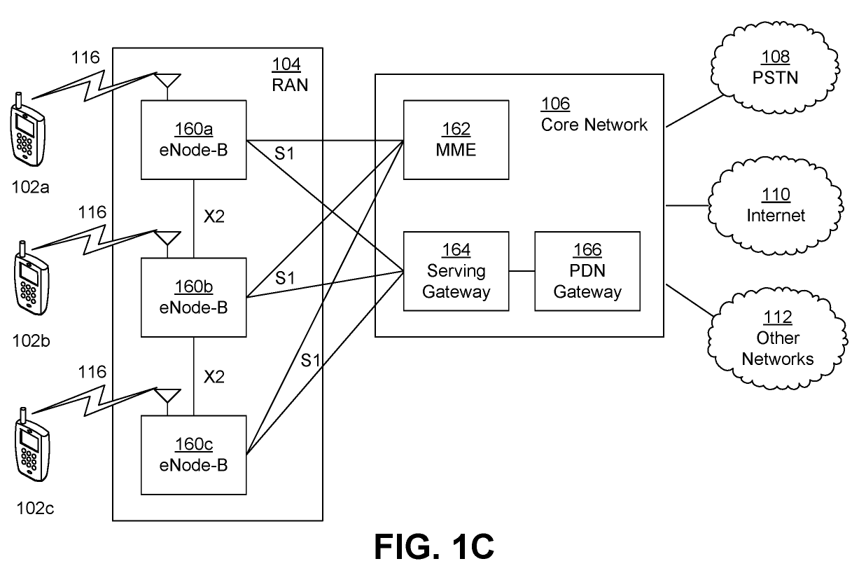

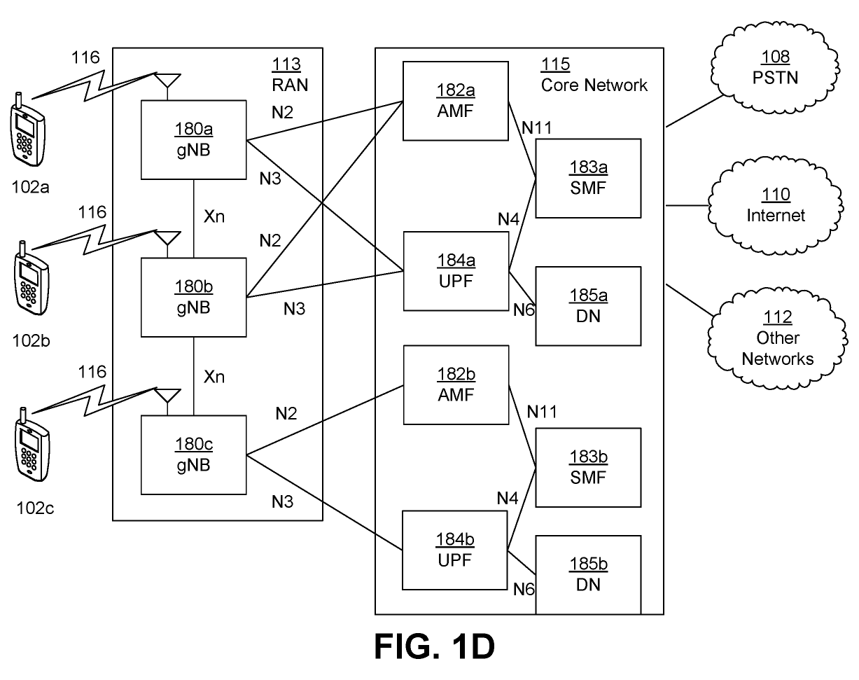

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In examples, a determination, a request, and/or reception of a data collection measurement gap may be performed. A determination may be made that a data collection measurement gap is needed (e.g., WTRU capabilities have been exceeded), and a request may be sent for a data collection measurement gap configuration, including, for example, accompanying assistance information (e.g., the preferred measurement gap configuration). Support may be provided for network-based requests for data collection measurement gaps (e.g., to support network-side data collection). If a measurement gap cannot be supported, prioritization of different data collection configurations may be applied (e.g., if the WTRU cannot support a measurement gap).

Reception and management of data collection measurement gap configurations may be supported. A WTRU may respond to a network-side measurement gap configuration (e.g., acknowledgment, rejection, and/or modification). Release, suspension, and/or modification of a data collection measurement gap may be performed. Examples supporting the determination may include that a measurement gap is no longer needed (e.g., data collection is no longer needed and/or data collection configurations are deconfigured). Support may be provided for the release, suspension, and/or modification of a data collection measurement gap, including the release, temporary suspension, and/or modification of a data collection measurement gap configuration and the resumption of normal scheduling.

For network-side data collection, both periodic and event-triggered (e.g., based on Layer 3 (L3) and/or Layer 1 (L1) measurements and/or beam-based events) data logging may be supported. Reporting of logged data may be performed via a low-priority Signaling Radio Bearer (SRB) and may rely on a network request (e.g., via the WTRU information request/response procedure similar to immediate Minimization of Drive Tests (MDT)). Logged data may include at least L1-Reference Signal Received Power (RSRP) values and/or beam IDs, and a WTRU may send an availability indication when data is available. A WTRU may notify the network and stop and/or pause data collection when a buffer limit is reached and/or may request a pause in data collection when power is constrained (e.g., in response to power constraints relative to a threshold).

For WTRU-side data collection, the initiation, termination, and/or configuration of data collection (e.g., measurement resource configuration and/or Associated ID) may be under network control. A WTRU may request a data collection configuration (if enabled by the network); however, the network may provide a data collection configuration at any time. Options under consideration for the transfer of WTRU-side data collection may include transfer to an Over-The-Top (OTT) server via the Core Network or via Operations, Administration, and Maintenance (OAM). Measurement gaps may be used in 5G NR to temporarily suspend transmission and/or data reception to allow a WTRU to perform measurements (e.g., for Radio Resource Management (RRM) and/or positioning purposes). A WTRU may need a measurement gap to measure, for example, a reference signal (RS) on a different frequency (e.g., for inter-frequency measurements) and/or in a different Bandwidth Part (BWP) (e.g., which may need BWP switching).

Whether a measurement is non-gap-assisted or gap-assisted may depend on the capability of a WTRU, the active BWP of the WTRU, and/or the current operating frequency. A WTRU may first report various capabilities regarding measurement gap requirements (e.g., support for uplink (UL) gaps in Frequency Range 1 (FR1) and/or Frequency Range 2 (FR2), supported gap patterns, and/or whether FR1 and/or FR2 gaps may be independently configured). A WTRU may further indicate via Radio Resource Control (RRC) signaling whether a measurement gap is needed for a particular frequency (e.g., via the Information Element (IE) needForGap).

Based on WTRU capability information and/or network deployment characteristics (e.g., the Search Space Monitoring Timing Configuration (SMTC) and/or reference signals for a neighboring carrier), a network may configure one or more measurement gaps via the IE measGapConfig, including information such as the Gap ID, gap length, gap type, and/or applicable frequencies. During a measurement gap, a WTRU may perform actions (e.g., re-tuning) necessary to conduct measurements. The WTRU may not report or transmit Hybrid Automatic Repeat Request (HARQ), Scheduling Request (SR), Sounding Reference Signal (SRS), or Channel State Information (CSI), nor may it transmit on the Uplink Shared Channel (UL-SCH), monitor the Physical Downlink Control Channel (PDCCH), or receive on the Downlink Shared Channel (DL-SCH).

The amount of collected data for AIML model training in Release 19 (Rel-19) may be assumed to be minimal, allowing for solutions such as transmission via the control plane and/or Location Protocol Positioning (LPP) signaling to be used for data transmission. However, data collection may increase significantly in Sixth-Generation (6G) networks, for example, due to additional AIML use cases and/or other features such as sensing.

As the number of configurations to support such data collection and/or corresponding measurements increases, additional strain may be placed on a WTRU to fulfill data collection obligations, potentially leading to issues in performing data collection (e.g., due to exceeding WTRU capabilities and/or invalid band combinations). Such issues may arise due to a lack of coordination between multiple entities responsible for data collection configuration (e.g., a gNodeB (gNB), a Location Management Function (LMF), and/or an Over-The-Top (OTT) server).

Under such circumstances, temporary pauses in transmission and/or data reception may be necessary (e.g., similar to the existing measurement gap framework used for mobility purposes) to fulfill data collection configuration(s). Direct reuse of the existing measurement gap framework may be considered; however, this may impose strict requirements that a WTRU must fulfill, often at the expense of throughput. Data collection, alternatively, may be considered a best-effort process, where a WTRU may occasionally choose to temporarily suspend data collection, for example, to boost throughput for a large data transmission and/or reception scenario. In this case, the requirements of existing measurement gaps may be overly restrictive.

A WTRU may complete data collection and no longer need a measurement gap, or the WTRU may be in a power-limited scenario and prefer not to perform data collection for the network. In such cases, the WTRU may choose to suspend and/or reject a measurement gap configuration. Such behavior is not currently supported by specification. Examples enabling a more dynamic and flexible measurement gap configuration for data collection may therefore be considered, allowing for WTRU request, suspension, and/or rejection of a measurement gap configuration (e.g., to support WTRU tradeoffs between data collection and/or transmission and/or reception throughput).

3GPP discussion on data collection has largely focused on the control, configuration, and/or transfer of collected data. There has not yet been discussion on the need for measurement gaps for data collection. Current measurement gap configurations are primarily used to support WTRU retuning to perform inter-frequency measurements (e.g., for mobility purposes). Such measurement gap configurations may be configured based on WTRU capability but with limited flexibility. Recent discussions in the context of eXtended Reality (XR) features have introduced the concept of the network informing a WTRU to skip a measurement gap; however, there is currently no concept of WTRU request and/or rejection of measurement gap configurations.

Examples described herein may support continued data collection for AIML training when the current set of data collection configuration(s) exceeds WTRU capability. A WTRU may request a measurement gap configuration based on whether it can no longer perform data collection according to current configuration(s). The WTRU may receive a measurement gap configuration and may resume data collection (e.g., within the configured measurement gap(s)) until determining that a measurement gap is no longer needed (e.g., the model has been trained). The WTRU may request the network to release, suspend, and/or modify the measurement gap for data collection and may resume network scheduling (e.g., regular network scheduling) based on network confirmation of measurement gap release, suspension, and/or modification.

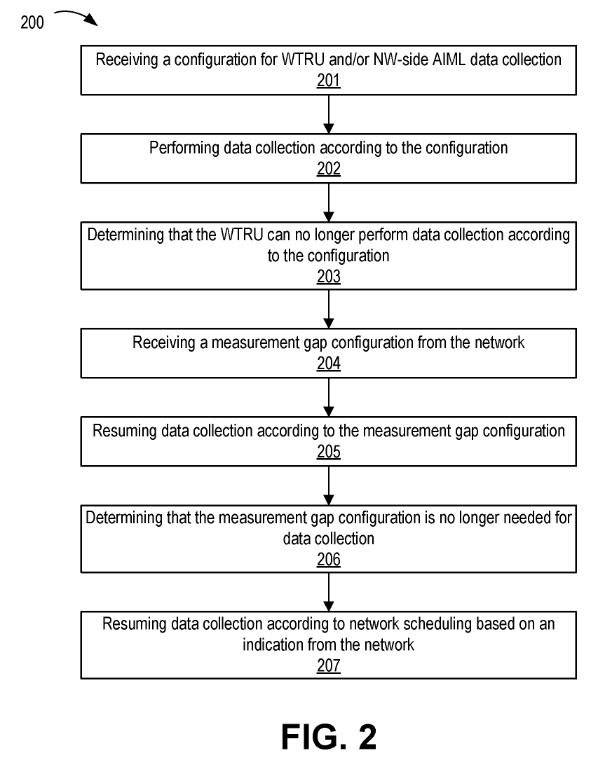

Referring now to FIG. 2, a diagram of a method 200 for performing measurement gap configuration for data collection by requesting, receiving, applying, and/or releasing a measurement gap configuration for AIML data collection is illustratively depicted.

At 201, a WTRU may receive one or more configurations (e.g., measurement resources and/or an Associated ID) for WTRU and/or network-side AIML data collection (e.g., for model training). Configurations may be provided by a gNB, an LMF, and/or may be requested on behalf of an external server (e.g., an OTT server). At 202, the WTRU may perform data collection according to the received configuration(s).

At 203, the WTRU may determine that it can no longer perform data collection according to the current (e.g., received one or more) configuration(s) (e.g., WTRU capabilities have been exceeded and/or an invalid band combination). The WTRU may send an indication to the network (e.g., via MAC CE and/or RRC signaling) that data collection cannot continue without a measurement gap. The indication may include one or more of an indication of the reason data collection cannot be fulfilled, an indication of which configuration(s) are causing the data collection to not be able to be performed, and/or an indication of a preferred measurement gap or gap configuration for the purposes of data collection.

At 204, the WTRU may receive a measurement gap configuration from the network (e.g., for the purposes of data collection). If the measurement gap configuration is to support network-side data collection, the WTRU may respond to the measurement gap configuration, indicating one or more of the following: acceptance of the measurement gap configuration, rejection of the measurement gap configuration, a proposed alternative data collection configuration, and/or a request to terminate network-side data collection.

At 205, the WTRU may resume data collection (e.g., within data collection measurement gap(s) according to data collection configuration(s)).

At 206, the WTRU may determine that a measurement gap is no longer needed for data collection (e.g., the model has been trained and/or data collection is no longer needed). The WTRU may notify the network (e.g., via MAC CE and/or RRC signaling) and may include one or more of the following: a request to release the measurement gap for data collection, a request to suspend (e.g., temporarily) the measurement gap for data collection (e.g., for the next X seconds and/or Y measurement gaps), and/or a request to modify the data collection measurement gap configuration (e.g., to reduce the number of gaps and/or the gap duration).

At 207, the WTRU may receive confirmation from the network that the data collection measurement gap is suspended, and the WTRU may perform regular transmission and reception (e.g., according to scheduling information).

Data collection measurement gaps may support data collection configurations without exceeding WTRU capability and may provide additional flexibility compared to existing measurement gap requirements.

The examples described herein may support large-scale data collection, including the request, configuration, and release, suspension, and/or modification of measurement gaps for WTRU-side and/or network-side data collection. These examples may involve one or more of the following components and/or subcomponents described herein.

The following terminology may be used throughout this document. The definitions provided below may serve as a general description; however, they are not exhaustive and do not preclude other meanings and/or uses.

Artificial intelligence may be broadly defined as behavior exhibited by machines. Such behavior may, for example, mimic cognitive functions to sense, reason, adapt, and/or act.

Machine learning may refer to a type of algorithm that may solve a problem based on learning through experience (e.g., data) without being explicitly programmed (e.g., configuring a set of rules). Machine learning may be considered a subset of AI. Different machine learning paradigms may be envisioned based on the nature of data and/or feedback available to the learning algorithm.

For example, a supervised learning approach may involve learning a function that maps an input to an output based on labeled training examples, wherein each training example may be a pair consisting of an input and the corresponding output. Additionally and/or alternatively, an unsupervised learning approach may involve detecting patterns in data without pre-existing labels. Furthermore, a reinforcement learning approach may involve performing a sequence of actions in an environment to maximize cumulative rewards.

In some examples, machine learning algorithms may be applied using a combination and/or interpolation of the above-mentioned approaches. For example, a semi-supervised learning approach may use a combination of a small amount of labeled data with a large amount of unlabeled data during training. In this regard, semi-supervised learning may fall between unsupervised learning (e.g., with no labeled training data) and supervised learning (e.g., with only labeled training data).

A given AIML model may be trained under certain WTRU-side and/or network-side additional conditions. For example, a WTRU-side condition may include the speed of the WTRU. Additionally and/or alternatively, network-side additional conditions may relate to network configurations and/or settings that the WTRU may not be aware of but that may impact model performance. For example, a Radio Link Failure (RLF) prediction model may perform differently if it is trained when the network was using a certain antenna pattern, beam pattern, power levels, and/or other network parameters. Additionally and/or alternatively, aspects related to network load may impact model performance.

Since the WTRU may not need to know all details of the network-side additional conditions (and the network may also not want to expose certain implementation details), the network may conceal these details by signaling one or more associated IDs to the WTRU. For example, during data collection for training a model, tagging may be performed to indicate the network-side additional conditions under which the model is trained. When a WTRU is configured to perform AIML-based RLF prediction, the WTRU may check the consistency between the conditions under which the AIML model was trained and the current conditions (e.g., current WTRU conditions and/or current associated ID(s) signaled by the network indicating current network conditions and/or settings).

An associated ID may be specific to a given functionality or may be applicable to multiple functionalities and/or all functionalities.

The following terminology may be used interchangeably throughout this document. The terms AI/ML and AIML may be used interchangeably. The terms data, measurements, report, and results may be used interchangeably. The terms indication, information, and message may be used interchangeably. The terms current cell, serving cell, and source cell may be used interchangeably. The terms target cell, candidate cell, and neighbor cell may be used interchangeably. The terms handover and cell switching may be used interchangeably. The terms functionality and procedure may be used interchangeably. The terms execute, apply, and perform may be used interchangeably. The terms send recovery message and initiate recovery may be used interchangeably to indicate the WTRU sending the re-establishment request or the handover complete message. The terms legacy and non-AIML may be used interchangeably. The terms inactive, inactivated, non-active, non-activated, dis-active, and dis-activated may be used interchangeably. The term a target cell that enables a functionality may have the same meaning as a functionality is applicable at the target cell.

A WTRU may be capable of collecting data for training an AIML model without necessarily being capable of AIML-based operations. The data collected may be used for training a network-sided model, a WTRU-sided model, or both the WTRU and network sides of a two-sided model (e.g., a CSI compression model where an encoder model is at the WTRU and a corresponding decoder model is on the network side).

The examples described herein may be agnostic to the type of AIML model and/or technique used by the WTRU (e.g., the algorithm used, the mechanism such as a neural network, the type of neural network, depth, and/or parameters/weights of the network), the origin of the model (e.g., WTRU vendor, operator, and/or network vendor), and/or how and where the model training is performed (e.g., the input data used for training, the location of training, and/or whether the training is performed offline or online).

A WTRU may be provided with one or more configurations to support data collection measurement gaps. Configurations to support data collection measurement gaps may include configurations for one or more of the following aspects: measurement gap(s) and/or AIML models and/or functionalities.

Data collection measurement gaps and AIML model and/or functionality configurations may be independently configured (e.g., there may be no dependency between configurations, and the WTRU may independently apply and/or remove configurations) or jointly configured (e.g., the two configurations may be linked such that both configurations may be jointly applied and/or removed, wherein the application and/or removal of one configuration may imply the application and/or removal of the other configuration).

Data collection measurement gaps may (e.g., additionally and/or alternatively) only be configured if supported by both the WTRU and the network. A WTRU may indicate capability for one or more aspects of data collection measurement gaps (e.g., prior to reception of associated configurations). A network may indicate support (e.g., per cell) for one or more aspects of data collection measurement gaps. A WTRU may, for example, only expect configuration from one or more cells that support the feature.

The examples described herein may support the indication of WTRU capability, network support, and/or the reception of one or more configurations for data collection measurement gaps.

In some examples, a capability may be utilized for data collection measurement gaps. The capability may relate to all aspects of data collection measurement gaps or may apply to individual aspects of measurement gap operation. Support for data collection measurement gaps may be reported by a WTRU and/or indicated by the network on a cell-specific basis.

A WTRU may indicate capability and/or support for one or more aspects of data collection measurement gaps. In one example, a WTRU may indicate a single capability to represent support for all aspects of data collection measurement gaps. In another example, a WTRU may report support for each aspect of data collection measurement gaps individually. A WTRU may indicate support for the configuration of data collection measurement gaps, the ability to request data collection measurement gaps, and/or the ability to provide assistance information for data collection measurement gap configuration. A WTRU may indicate support for network-requested data collection measurement gaps, the ability to modify data collection configuration priorities, and/or the ability to reject data collection measurement gap configurations. A WTRU may indicate the ability to skip measurement gaps, temporarily suspend and/or modify data collection measurement gaps, and/or update and/or modify data collection measurement gap configurations. A WTRU may also indicate the ability to store data collection measurement gap configurations.

A WTRU may report capability for one or more of these aspects of data collection measurement gaps, for example, via the WTRU capability transfer procedure. In another example, a WTRU may indicate capability and/or support using one or more of the following methods. Capability indication may be provided via random access, including the use of one or more dedicated resources and/or random access preamble partitioning (e.g., a set of reserved preambles, random access occasions, and/or Radio Network Temporary Identifiers (RNTIs)). Capability indication may be provided upon RRC connection establishment and/or resumption (e.g., via Msg3 and/or Msg5). Capability indication may be provided upon request from the network (e.g., upon reception of a capability enquiry message). Capability indication may also be provided via WTRU assistance information.

In some examples, capability to support, perform, execute, and/or initiate one or more aspects of data collection measurement gaps may be linked to one or more other configurations. For example, a network may assume that a WTRU is capable of one or more aspects of data collection measurement gaps based on the activation, state, and/or configuration of one or more of the following: an AIML model and/or functionality configuration, an AIML model and/or functionality activation, and/or an AIML model and/or functionality availability.

In another example, capability and/or support for initiation of one or more aspects of data collection measurement gaps may be reliant on one or more characteristics of a WTRU. These characteristics may include the performance of an AIML model and/or functionality, WTRU speed, remaining WTRU power, WTRU processing ability, and/or WTRU location (e.g., within a certain set of cells, using one of a set of specific beams, and/or based on GPS location). Capability may also be dependent on whether a particular type of service is in use (e.g., related to one or more specific network slices and/or QoS Class Identifiers (QCIs)).

If a WTRU is configured for data collection measurement gaps and an associated configuration is not present, active, and/or the WTRU characteristics are not suitable, the procedure may be assumed to be temporarily disabled (e.g., the WTRU may not initiate the procedure) or inactive. The WTRU may indicate, subject to configuration, to the network that data collection measurement gaps are temporarily inactive (e.g., via a MAC CE, Uplink Control Information (UCI), and/or RRC signaling). In some examples, the WTRU may also report the reason why the procedure is inactive (e.g., a joint configuration is disabled and/or the WTRU characteristics are not suitable).

A network may indicate support for data collection measurement gaps. Support for data collection measurement gaps may be provided per cell, per Public Land Mobile Network (PLMN), per frequency, per Tracking Area (TA), and/or per Radio Access Network (RAN) Notification Area (RNA). The indication may be provided as a flag and/or bit in system information to indicate support for data collection measurement gaps. A network may indicate support for a specific aspect of the procedure (e.g., a cell may support configuration release but not modification). A network may indicate, within system information and/or via RRC configuration, a list of one or more cells that support data collection measurement gaps.

In some examples, a WTRU may only use data collection measurement gaps, or one or more aspects of data collection measurement gaps, if the network supports the procedure. For example, a WTRU may only temporarily suspend data collection measurement gaps if supported by the network.

In some examples, a WTRU may receive one or more configurations to support one or more AIML operations. Such configurations may be provided per functionality and/or per model. For example, a different configuration or set of configurations may be provided for a detailed model versus a general model. Examples of configurations may include one or more configurations for model training, inference, performance monitoring, data collection, and/or applicability reporting.

A WTRU may receive one or more configurations for AIML model training. Examples of configurations for model training may include one or more of the following: criteria for updating a model, criteria for determining when a model is done training, criteria for downloading a new model, and/or criteria for re-training a model. Configurations to train a model may also be included, such as training duration and/or number of iterations.

A WTRU may receive one or more configurations for AIML inference. Examples of configurations for inference may include one or more of the following: models in which inference may be performed, information characteristics needed for input, and/or network-side additional conditions and/or associated ID(s) on which the model has been trained.

A WTRU may receive one or more configurations for AIML performance monitoring. Examples of configurations for performance monitoring may include one or more of the following: when performance monitoring may be performed, such as periodicity and/or duration, criteria for performance monitoring, such as thresholds, and/or criteria to report performance monitoring results, such as when performance has dropped below a threshold.

A WTRU may receive one or more configurations for AIML data collection. Examples of configurations for data collection may include one or more of the following: measurement configurations, associated ID(s), and/or network-side additional conditions. Configurations may also include limits on the amount of data collected, types of data and/or events to collect, triggers to report collected data, and/or formats to report collected data.

A WTRU may receive one or more configurations for AIML applicability reporting. Examples of configurations for applicability reporting may include one or more of the following: whether applicability may be reported proactively and/or reactively, whether the WTRU may report non-applicability, and/or whether the WTRU may transmit an update during a connected state regarding the applicability of a model. Configurations may also include triggering conditions to report applicability, such as when a functionality becomes non-applicable.

In some examples, a WTRU may adapt a measurement gap configuration. Aspects of measurement gap adaptation, including whether the measurement gap may be adapted, how the measurement gap may be adapted, criteria for adapting a measurement gap, and/or management of multiple measurement gaps, may themselves be configured. Appropriate configuration of measurement gap adaptation may ensure that WTRU behavior is controlled and that the WTRU and network are aligned on when the WTRU should perform measurement gaps.

A WTRU may be provided with one or more measurement gap configurations. The WTRU may receive one or more measurement gap configurations as part of an RRC connection establishment, an RRC resume, or during an RRC connection. A WTRU may receive multiple measurement gap configurations at once, or the WTRU may modify, add, and/or remove one or more measurement gap configurations throughout an RRC connection (e.g., via the gapToReleaseList or gapToAddModList).

A measurement gap configuration may have an associated configuration (e.g., provided by measGapConfig) consisting of one or more of the following information elements, as defined in TS 38.331. A measGapId may indicate the ID of a measurement gap configuration. A gapType may indicate whether the gap applies to FR1, FR2, or both. A gapOffset may indicate the gap offset of the gap pattern with MGRP indicated in the field mgrp. An mgl may indicate the measurement gap length in milliseconds. An mgrp may indicate the measurement gap repetition period in milliseconds. An mgta may indicate the measurement gap timing advance in milliseconds. A refServCellIndicator may indicate the serving cell whose SFN and subframe are used for gap calculation for this gap pattern. A preConfigInd may indicate whether the measurement gap is a pre-configured measurement gap. A gapSharing may indicate the measurement gap sharing scheme. A gapPriority may indicate the priority of the measurement gap.

A measurement gap configuration may include additional configurations to support the temporary suspension and/or modification of data collection measurement gaps (e.g., adaptation criteria, measurement gap skipping, and/or temporary modification of a measurement gap). These additional configurations may be included within a measurement gap configuration and/or as part of a separate configuration that may be linked to a measurement gap configuration (e.g., by indication of the associated measurement gap ID). If a WTRU receives a data collection measurement gap configuration without such additional adaptation configurations, the WTRU may need explicit deconfiguration and/or reconfiguration by the network (e.g., via RRC or MAC CE signaling) to suspend or modify a measurement gap configuration.

A data collection measurement gap configuration may include a different set of values (e.g., one or more values of the measurement gap configuration) that may be applied if and/or while the data collection measurement gap is in an adapted state. For example, different values may be applied if adaptation criteria are satisfied, while adaptation criteria are satisfied, and/or during a time period indicated within an adaptation criterion. The values within the measurement gap configuration that a WTRU may apply while the measurement gap is not adapted may be referred to as the "baseline measurement configuration," while the values applied while the measurement gap configuration is in an adapted state may be referred to as the "adapted measurement gap configuration."

A network may provide, update, modify, remove, add, and/or indicate all or part of a data collection measurement gap configuration and/or configurations to support measurement gap adaptation. For example, criteria, methods, alternative values, and/or time periods may be signaled via RRC signaling (e.g., RRC Setup and/or RRC Resume) or via one or more of the following signaling methods: MAC CE, DCI, RACH (e.g., MSG2, MSG4, and/or MSGB), PDCCH/PUSCH, and/or NAS.

In some examples, a WTRU may receive one or more configurations to support the determination of the need for and/or the request for a data collection measurement gap configuration.

A WTRU may receive one or more configurations for the determination and request for a data collection measurement gap. Examples of such configurations may include an indication (e.g., a flag or bit) to enable a data collection measurement gap configuration request. A configuration may also include an indication (e.g., a flag or bit) to enable the inclusion of assistance information (e.g., a preferred measurement gap configuration) along with a data collection measurement gap request. An indication (e.g., a flag or bit) may be provided to request the reason for a data collection measurement gap configuration request. A configuration may include an indication (e.g., a flag or bit) to identify the data collection configuration that is causing the need for a measurement gap configuration in the request. Configurations to adjust the priority of a data collection configuration may also be provided (e.g., if the WTRU cannot fulfill all data collection obligations).

A WTRU may receive one or more configurations for the reception of and WTRU response to a data collection measurement gap configuration. Examples of such configurations may include an indication (e.g., a flag or bit) to enable WTRU rejection of a data collection measurement gap configuration. Configurations may also include conditions (e.g., thresholds) to apply the data collection measurement gap configuration.

In some examples, a WTRU may receive one or more configurations to support the release, suspension, and/or modification of a data collection measurement gap configuration. These configurations may support the determination that a data collection measurement gap is no longer needed and/or specify follow-up actions.

A WTRU may receive one or more configurations for determining that a data collection measurement gap is no longer needed. Examples of such configurations may include an indication (e.g., a flag or bit) to enable the WTRU to release a data collection measurement gap configuration based on other high-priority transmissions and/or receptions.

A WTRU may receive one or more configurations for the release, suspension, and/or modification of a data collection measurement gap. Examples of such configurations may include an indication (e.g., a flag or bit) to enable the WTRU to modify a data collection measurement gap configuration. A configuration may also include an indication (e.g., a flag or bit) to enable the WTRU to request the deactivation of a data collection configuration.

Additional data collection volume (e.g., driven by additional use cases and needs) may result in additional configurations and measurements that a WTRU is needed to perform. Depending on the entity requesting the data, a WTRU may maintain multiple configurations that may not necessarily be coordinated (e.g., between a gNB, an OTT server, and an LMF). In such cases, a WTRU may be configured with data collection configurations that exceed its capabilities.

In such scenarios, a WTRU may request a measurement gap to support various data collection obligations. The existing measurement gap framework is rigorously defined (e.g., to ensure proper mobility) and may impose too many restrictions when applied to data collection. Examples introduced herein support a new category of measurement gaps specifically for data collection, including the need determination, request, configuration, and WTRU response.

A WTRU may request a measurement gap for the purposes of data collection. Such requests may be based on the determination that a WTRU may not be able to fulfill current data collection configurations. Alternatively, in the case of network-side data collection, a network may request that a WTRU configure a data collection measurement gap to support network-side data collection.

A WTRU may determine that it can no longer perform data collection according to current configurations. Reasons a WTRU may not be able to continue data collection according to current configurations may include one or more of the following. WTRU capabilities may have been exceeded (e.g., retuning time and/or frequency switching). Invalid band combinations may be present. Data collection configurations may conflict (e.g., a WTRU may be configured to measure different measurement signals that conflict, where configurations may be provided by different network entities such as a gNB and an LMF). Current WTRU scheduling (e.g., scheduling conflicts) may impact the ability to perform data collection (e.g., a WTRU may be scheduled to transmit and/or receive data at the same time as data collection).

Upon determining that a WTRU can no longer support current data collection obligations, the WTRU may perform one or more of the following actions. A WTRU may notify a network (e.g., a gNB and/or an LMF) or an external OTT server that the WTRU cannot fulfill data collection obligations based on current configurations. A WTRU may request a measurement gap configuration for data collection purposes. A WTRU may suspend data collection (e.g., all configurations and/or one or more configurations for data collection), and may prioritize data collection (e.g., between configurations).

In some examples, a WTRU may request a data collection measurement gap configuration from a network. Whether a WTRU may request a data collection measurement gap configuration may be subject to an enable and/or disable indication by the network. For example, the network may disable the ability to request a data collection measurement gap configuration via a flag and/or bit. The ability to request a data collection measurement gap configuration may also be subject to prohibit conditions. For example, a WTRU may be configured with a time period that begins upon transmission of a data collection measurement gap request, during which the WTRU may not transmit another request for the configured duration. These examples may prevent continuous requests and/or reconfiguration of a data collection measurement gap configuration, thereby reducing signaling overhead and improving scheduling consistency.

A request for a data collection measurement gap configuration may be triggered based on, for example, one or more of the following. A request may be triggered by a determination that a WTRU cannot fulfill data collection obligations according to current configurations (e.g., as described above). A request may be triggered if the priority of a data collection configuration has increased (e.g., the WTRU is to collect a large amount of high-priority data quickly to, for example, train a new model, which may need a data collection measurement gap to fulfill). A request may also be triggered if the current data collection measurement gap configuration is no longer suitable (e.g., it is not large enough and/or the periodicity should be increased and/or decreased).

A data collection measurement gap configuration request may include, for example, one or more of the following. A request may include a request indicator (e.g., a flag and/or bit) for a data collection measurement gap configuration. A request may include an indication of the priority of the data collection (e.g., the WTRU needs a data collection configuration for high-priority data collection). A request may indicate whether the data collection measurement gap configuration is needed for WTRU-side and/or network-side data collection.

A WTRU may include additional assistance information within a data collection measurement gap request (e.g., to support measurement gap configuration). Additional assistance information may include, for example, one or more of the following. A WTRU may include the reason that it cannot fulfill data collection (e.g., that WTRU capabilities are exceeded, invalid band combinations, etc.). A WTRU may indicate which configuration(s) are causing the issue (e.g., the WTRU may indicate an index associated with the data collection configuration). A WTRU may indicate a preferred measurement gap and/or gap configuration for the purposes of data collection (e.g., the WTRU may indicate one or more measurement gap characteristics like gap width, periodicity, etc.). A WTRU may indicate its buffer status (e.g., to ensure that the WTRU can support additional measurement gaps without impacting the ability for the WTRU to transmit data).

A WTRU may request a data collection measurement gap configuration via RRC signaling or via one or more of the following signaling methods: MAC CE, DCI, RACH (e.g., MSG2, MSG4, MSGB), PUCCH/PUSCH, NAS, or LPP. In an example, which signaling method is used may depend on which entity is responsible for the data collection. The WTRU may use RRC, MAC CE, or DCI to request a data collection configuration for an AIML use case that is related to and/or controlled via RAN (e.g., AIML beam management or CSI prediction and/or compression). The WTRU may use NAS or LPP signaling to request a data collection configuration for an AIML use case that is related to and/or controlled via the core network (e.g., AIML for positioning).

A WTRU may receive a request from a network for a data collection measurement gap configuration (e.g., to support network-side data collection for the purposes of network model training). A network request for a data collection configuration may contain, for example, one or more of the following. A request may include an indication (e.g., a flag and/or bit) to request a measurement gap configuration for data collection purposes. A request may indicate the importance of applying the data collection measurement gap to the network (e.g., whether the collected data is high priority and/or low priority). A request may also include suggested measurement gap characteristics (e.g., suggested gap duration and/or periodicity).

A network may provide a data collection measurement gap configuration along with the above request. If a WTRU accepts the application of the configuration, the WTRU may apply the configuration and simply acknowledge the request without additional information. Upon transmission of the acknowledgment, it may be assumed that the WTRU will apply the data collection measurement gap configuration. Such examples may allow for the quick application of a measurement gap configuration. In another example, a network may provide a data collection measurement gap configuration only after acceptance by a WTRU. This may allow the network to, for example, account for WTRU-recommended characteristics for the measurement gap configuration (e.g., acceptable gap width and/or periodicity) as well as reduce signaling overhead by avoiding the provision of an unsuitable initial configuration.

A network may request a data collection measurement gap via RRC signaling or via one or more of the following signaling methods: MAC CE, DCI, RACH (e.g., MSG2, MSG4, and/or MSGB), PDCCH/PDSCH, LPP signaling, and/or NAS. In one example, the signaling method used may depend on the network entity responsible for requesting data collection. A network may use RRC, MAC CE, and/or DCI to request a data collection configuration for an AIML use case that is related to and/or controlled via a RAN (e.g., AIML beam management or CSI prediction and/or compression). In another example, a network may use NAS and/or LPP signaling to request a data collection configuration for an AIML use case that is related to and/or controlled via a core network (e.g., AIML for positioning).

A WTRU may choose not to use a measurement gap for data collection (e.g., despite WTRU capabilities being exceeded). Examples of when a WTRU may wish to not use a measurement gap configuration may include, for example, cases in which a WTRU has high-priority and/or large volumes of data to transmit and does not wish to reduce throughput by introducing measurement gaps. A WTRU may also avoid measurement gaps if it is in poor radio conditions (e.g., poor RSRP and/or limited coverage) and must prioritize other transmissions and/or receptions.

In such scenarios, based on a determination that a WTRU cannot fulfill data collection obligations and that a measurement gap is not suitable, a WTRU may not perform all data collection measurements and/or obligations. Instead, a WTRU may prioritize a subset of the data collection measurements and/or suspend data collection entirely. In one example, a WTRU may prioritize between different data collection configurations. How a WTRU prioritizes a given data collection configuration may be based on, for example, one or more of the following. A WTRU may prioritize data collection based on configuration (e.g., whether a data collection is configured as high priority versus low priority). A WTRU may prioritize based on a network request, based on a request from an external entity (e.g., an OTT server), and/or based on data collection characteristics (e.g., data collected is outside a standard deviation and/or significantly different from an average). A WTRU may also prioritize based on the associated ID of a data collection configuration, based on the use case of the data collection (e.g., AIML positioning, CSI, and/or beam management), and/or based on the entity configuring and/or requesting the data collection configuration (e.g., a gNB, an LMF, and/or an OTT server). A WTRU may also prioritize based on whether data collection is performed for the WTRU (e.g., WTRU-side data collection) or for the network (e.g., network-side data collection).

In some examples, a WTRU may continue to perform data collection for all configurations but may only collect data on a subset of measurement resources within the data collection configurations. A WTRU may, for example, collect data on a factor N (e.g., 50%) of measurement resources within various data collection configurations. A WTRU may also apply different factors (e.g., 10% and/or 90%) to different configurations (e.g., based on the priority of a data collection configuration).

A WTRU may receive a data collection measurement gap configuration (e.g., in response to a WTRU request). WTRU actions upon reception of a data collection measurement gap may depend on whether the data collection measurement gap is based on a WTRU request, whether the data collection gap fulfills WTRU requirements, and/or whether the data collection measurement gap is to support WTRU-side or network-side data collection.

A WTRU may receive a measurement gap configuration for data collection purposes. The WTRU may receive such a configuration based on one or more of the following scenarios. A measurement gap configuration may be received based on a WTRU request (e.g., according to a WTRU determination that data collection obligations need a data collection configuration). A measurement gap configuration may also be received along with a new data collection configuration (e.g., to support the new data collection configuration). In an example, a measurement gap configuration may be received based on a network decision (e.g., the WTRU has not requested the configuration, and it is instead provided based on a network determination).

Upon reception of a data collection measurement gap configuration, a WTRU may perform a different action depending on the purpose of the measurement gap configuration. For example, a WTRU may perform one or more of the following actions upon reception of one or more data collection measurement gap configurations. A WTRU may apply the data collection measurement gap (e.g., if the measurement gap was received in response to a WTRU request and/or the measurement gap configuration aligns with the requested characteristics of the gap configuration). A WTRU may request to modify the gap configuration (e.g., if the WTRU has requested a data collection measurement gap but the received configuration is not suitable for data collection obligations). A WTRU may reject a new data collection configuration (e.g., if the addition of the new data collection configuration would cause the WTRU to exceed its capabilities and/or need a new measurement gap, which may not be in the WTRU’s interest at that time). A WTRU may reject the application of a measurement gap (e.g., due to the measurement gap being needed for network-side data collection).

A WTRU may be provided with a data collection measurement gap that is not currently necessary but may be at some point in the future. For example, WTRU capabilities may not currently be exceeded but may be close (e.g., within a margin of WTRU capabilities). In such cases, a WTRU may not immediately activate the data collection measurement gap and may instead store the gap for future use (e.g., in case the addition of another measurement gap configuration causes the WTRU to exceed its capabilities).

A WTRU may receive multiple measurement gap configurations for data collection purposes. Such configurations may be associated with different measurement gap characteristics (e.g., different gap widths, start times, and/or periodicities). Providing multiple measurement gaps may support WTRU selection of the most suitable gap based on current WTRU characteristics (e.g., buffer status and/or data collection obligations). Upon reception of multiple data collection measurement gaps, a WTRU may apply one or more gap configurations and/or store them (e.g., the WTRU maintains the configuration but does not apply the measurement gap). A WTRU may notify the network if the WTRU deactivates a currently applied measurement gap and/or applies a currently stored measurement gap configuration.

In some examples, a data collection measurement gap configuration may be associated with conditions for applying the measurement gap. Examples of conditions for applying a measurement gap configuration may include one or more of the following. A WTRU may apply the measurement gap configuration if there is sufficient space in the buffer (e.g., the buffer is not full and/or is within X% of being full). A WTRU may apply the measurement gap configuration if it does not have other data buffered for transmission. A WTRU may apply the measurement gap configuration only if it does not have data with specific characteristics buffered for transmission (e.g., the WTRU does not have high-priority data awaiting transmission). A WTRU may apply the measurement gap configuration only if it is under adequate radio conditions (e.g., the RSRP, RSRQ, and/or SINR is above a configured threshold). A WTRU may also apply the measurement gap configuration if it is currently training a model.

If a data collection measurement gap configuration is associated with conditions for its application, a WTRU may apply the data collection measurement gap if such conditions are satisfied (e.g., upon satisfaction of the conditions, a WTRU may apply the data collection measurement gap). While the conditions remain satisfied, a WTRU may maintain the data collection measurement gap. Upon termination of the conditions, a WTRU may no longer apply the measurement gap configuration. To ensure coordination between a network and a WTRU, the WTRU may report when the conditions are fulfilled and/or no longer fulfilled.

In some examples, a WTRU may receive a data collection measurement gap for the purposes of network-side data collection (e.g., the WTRU is configured to perform measurements and collect data on behalf of the network to support network-side model training). In some scenarios, the imposition of a measurement gap to collect data on behalf of the network may place a burden on the WTRU (e.g., the WTRU has high-priority data to transmit and cannot do so due to the reduced throughput introduced by the data collection measurement gap). In such cases, the WTRU may not necessarily want to perform the data collection or apply the corresponding measurement gap configuration.

Upon reception of a measurement gap configuration to support network-side data collection, the WTRU may respond to the network with one or more of the following actions. A WTRU may accept the measurement gap configuration. A WTRU may reject the measurement gap configuration. A WTRU may propose an alternative data collection configuration. A WTRU may request to terminate network-side data collection.

If a WTRU responds with acceptance of the measurement gap configuration, the network may assume that the WTRU will operate according to the measurement gap configuration and will not schedule the WTRU within the indicated periods. If a WTRU rejects the network request, the network may attempt to provide an alternative suitable gap configuration but may continue to schedule the WTRU (e.g., until a suitable gap configuration has been negotiated between the WTRU and the network).

If a WTRU proposes an alternative data collection configuration, the network may perform one or more of the following actions. A network may provide a revised data collection measurement gap configuration according to the WTRU’s suggestion. A network may respond with a further modified data collection measurement gap configuration (e.g., one that is not the same as the initial configuration or the WTRU configuration but is instead a compromise between the two). A network may deactivate the network-side data collection configuration (e.g., the network acknowledges that the current data collection configuration is overly burdensome to the WTRU and, instead of configuring a modified gap, simply deactivates network-side data collection).

If a WTRU responds with a request to terminate network-side data collection, the network may respond with a deactivation command for the network-side data collection configuration.

Although the application of a measurement gap supports data collection, it may impact WTRU throughput due to the temporary pause in scheduling during the measurement gap (e.g., to support the measurement and collection of WTRU data). It is therefore in the interest of both the WTRU and the network that a WTRU only applies a data collection measurement gap when needed (e.g., when a WTRU cannot perform data collection unless the measurement gap is configured).

Procedures may therefore be necessary to determine when a data collection measurement gap is no longer needed or suitable for a WTRU to ensure that the WTRU can balance data collection obligations with throughput. Such behavior may differ from existing measurement gap configurations, as the collection of data may be lower priority than measurement gaps used for purposes such as mobility. This may allow additional flexibility in the use of a data collection measurement gap configuration.

Examples described herein support the determination that a data collection measurement gap and/or gap configuration is no longer needed or suitable, including WTRU requests and actions for the release, suspension, and/or modification of a data collection measurement gap. Upon taking such actions, a WTRU may return (e.g., permanently or temporarily) to normal scheduling operation.

In some examples, a WTRU may determine that a data collection measurement gap is no longer needed. This determination may be semi-static (e.g., the measurement gap is no longer needed at all) or dynamic (e.g., one or more measurement gaps may temporarily not be needed). To support maximized throughput, examples and procedures are defined to ensure that a WTRU only uses a data collection measurement gap when necessary.

A WTRU may determine that a configured measurement gap is no longer necessary or suitable in its current configuration. In such cases, a WTRU may release, suspend, or modify the data collection measurement gap accordingly. A WTRU may determine to perform such actions based on one or more of the following. Data collection may no longer be needed (e.g., a model has been trained). A conflicting data collection configuration may have been deconfigured and/or deactivated. An additional data collection configuration may have been configured or activated (e.g., a WTRU may need to increase the gap duration or periodicity). Data collection and/or another WTRU action may be higher priority than data collection (e.g., the transmission and/or reception of high-priority data). A WTRU may have performed mobility to a cell where data collection is not supported. The associated ID of a cell may have changed such that the current data collection configuration is no longer suitable.

Depending on the reason a data collection measurement gap is no longer needed, a WTRU may release, suspend, or modify the data collection measurement gap. Such changes may be permanent (e.g., the configuration is released) or temporary. WTRU actions and the degree to which a data collection measurement gap configuration is modified are described in further detail herein below.

In some examples, methods to acquire, reacquire, adapt, or release configurations for the differentiated handling and reporting of collected data may be necessary to ensure that a WTRU can balance throughput requirements with data collection obligations. Such procedures may include determining that a data collection measurement gap is permanently or temporarily not needed and the corresponding configuration handling.

A WTRU may determine that a measurement gap is no longer needed at all. For example, a configuration that had been causing issues may have been deconfigured, and/or a model for which data was being collected may no longer be needed because it is fully trained. In such scenarios, a WTRU may request that a data collection measurement gap configuration be released. Within a release request, a WTRU may include, for example, the reason why a data collection measurement gap is no longer needed (e.g., a model has been trained) as well as an indication that one or more data collection configurations are no longer needed. In another example, a WTRU may indicate that a data collection configuration is no longer needed. Upon reception of this request, a network may detect that a data collection measurement gap is also no longer needed (e.g., based on assistance information provided by a WTRU indicating that the configuration was originally needed for a measurement gap). Upon reception of a deconfiguration request for a data collection configuration, a network may also deconfigure a data collection measurement gap configuration. In another example, a data collection configuration may be for network-side data collection (e.g., in which case a network is responsible for determining when a data collection configuration is no longer necessary). In this case, when a network determines that a data collection configuration is no longer needed, it may also deconfigure and/or release a data collection measurement gap configuration.

In another example, a WTRU may determine that a measurement gap configuration is only temporarily not needed. A WTRU may temporarily disable a data collection measurement gap based on one or more of the following. A WTRU may temporarily suspend data collection (e.g., the data collection buffer is full). The associated ID of a cell may have changed. Other transmission and/or reception responsibilities may be higher priority than data collection (e.g., a WTRU has a large packet or higher-priority data needing additional throughput).

A WTRU may also temporarily disable a data collection measurement gap based on WTRU characteristics. Examples of WTRU characteristics may include WTRU speed and/or position, WTRU power and/or battery level, and/or WTRU processing capability and/or load.

If one or more of the above conditions are met, a WTRU may maintain a data collection measurement gap configuration but may request that a network temporarily modify and/or suspend a data collection measurement gap. In another example, a WTRU may autonomously perform measurement gap suspension.

In some examples, a WTRU may request to temporarily perform data collection measurement gap skipping. A WTRU may receive a confirmation from a network for measurement gap skipping, which may enable and/or instruct the WTRU to not perform measurements within one or more data collection measurement gaps of a measurement gap configuration.

A confirmation for data collection measurement gap skipping may include one or more of the following pieces of information. A confirmation may indicate whether skipping applies to one measurement gap or multiple measurement gaps. A confirmation may indicate the number of measurement gaps to which skipping applies. A confirmation may indicate a time to start skipping measurement gaps and/or a time to end skipping measurement gaps. A confirmation may also indicate a duration (e.g., a time period) for which to skip measurement gaps.

Upon detecting a change in the need for a data collection measurement gap configuration, a WTRU may request to modify one or more aspects of the current configuration and/or apply a new configuration. How a WTRU detects which aspects of a configuration to change may be based on conditions associated with the configuration and/or specific aspects of the configuration. For example, a WTRU may be provided with one or more thresholds. If a threshold is exceeded, or if a value falls below a threshold, a WTRU may apply an alternative configuration and/or value for the same configuration.

A WTRU may request and receive a configuration to temporarily modify one or more measurement gaps. A WTRU may receive a configuration to determine how long it should apply the temporary measurement gap configuration adaptation. A temporary measurement gap configuration may include one or more of the following. A configuration may specify a start time for the modification. A configuration may specify an end time for the modification. A configuration may specify a duration for the modification.

During the modification period, a WTRU may adapt aspects of a measurement gap configuration. Configurations to support such temporary modifications may include, for example, which components of a measurement configuration to adapt (e.g., length, offset, and/or periodicity). A configuration may specify how to adapt a measurement gap configuration. A configuration may specify whether to increase a current configuration value (e.g., to the next value or a default value). A configuration may specify whether to decrease a current configuration value (e.g., to a previous value or a default value). A configuration may also specify whether to apply a different value (e.g., a temporary value provided).

A WTRU may be provided with revised data collection measurement gap configurations upon establishment and/or resumption of an RRC connection (e.g., within an RRC Setup and/or Resume message), upon handover to another cell (e.g., within a HO command and/or RRC reconfiguration message with a reconfiguration with sync), or at any time during an active RRC connection (e.g., via an RRC reconfiguration message without reconfiguration with sync). In other examples, configurations for data collection measurement gap configurations may be indicated, configured, and/or provided via one or more of the following signaling methods: SIB (e.g., a new SI block or within another existing SIB), NAS, MAC CE, DCI, RACH (e.g., MSG2, MSG4, and/or MSGB), RRC, and/or PDCCH/PUSCH.

A WTRU may receive different information and/or components of a configuration for a data collection measurement gap via different signaling methods. For example, a WTRU may receive some dedicated configuration aspects via RRC signaling and some other configurations or information via system information. If a WTRU is provided with a dedicated configuration and/or indication related to the differentiated handling and reporting of collected data, the WTRU may override other common configuration information (e.g., received via broadcast signaling) or may combine the dedicated configuration with one or more pieces of common configuration information. In another example, a WTRU may use the most recently received information in a configuration regardless of the signaling method.

A WTRU may receive one or more alternative configurations using one signaling method (e.g., via system information or dedicated RRC signaling). Using another type of signaling (e.g., via dedicated RRC signaling or MAC CE), a network may select or indicate which of the one or more alternative configurations to apply.

In some examples, a WTRU may resume normal scheduling operation such that the WTRU may resume the reception and/or transmission of data according to network scheduling and may no longer be restricted by a data collection measurement gap. A WTRU may resume normal scheduling semi-statically (e.g., upon release of a data collection measurement gap configuration) or temporarily (e.g., for the duration that a data collection measurement gap is skipped). Resumption of normal scheduling may need confirmation from a network (e.g., a network approves the configuration suspension and assigns a WTRU a scheduling grant). In another example, a WTRU may resume normal scheduling autonomously (e.g., a WTRU restarts the use of a CG occasion that was formerly within a data collection measurement gap and was thus unable to be used).

1. A wireless transmit/receive unit (WTRU) comprising:
a processor configured to:
receive a data collection configuration, wherein the data collection configuration comprises an indication of measurement resources and an identifier associated with WTRU-side or network-side artificial intelligence or machine learning (AIML) data collection;
perform data collection based on the data collection configuration;
determine that the WTRU cannot continue to collect data in accordance with the data collection configuration;
send, to a network, an indication that the WTRU cannot continue to collect data in accordance with the data collection configuration;
receive, from the network, an indication for a measurement gap configuration; and
resume data collection based on the data collection configuration and in accordance with the measurement gap configuration.

2. The WTRU of claim 1, wherein the data collection configuration comprises at least one of an indication of a data reporting requirement, a measurement periodicity, or a preferred measurement gap configuration.

3. The WTRU of claim 1, wherein the identifier associated with WTRU-side or network-side AIML data collection corresponds to data indicating at least one of network-side AIML model training conditions, a classification label for collected data, or a reference to a previously trained model.

4. The WTRU of claim 1, wherein the processor is configured to determine that the WTRU cannot continue to collect data in accordance with the data collection configuration based on at least one of exceeding WTRU processing capability due to at least one of retuning time or frequency switching constraints, an invalid band combination, a measurement scheduling conflict, or conflicting configurations from multiple network entities.

5. The WTRU of claim 1, wherein the processor is configured to:
determine that the WTRU cannot continue to collect data in accordance with the data collection configuration; and
request the measurement gap configuration from the network based on the determination that the data collection cannot continue in accordance with the data collection configuration.

6. The WTRU of claim 1, wherein the indication comprises a reason data collection cannot continue, a preferred measurement gap configuration, or an indication of one or more configurations preventing the WTRU from resuming data collection, wherein the one or more configurations preventing the WTRU from resuming data collection comprise an indication of a capability limitation of the WTRU, an indication of an invalid band combination, an indication of conflicting data collection configurations, or an indication of a scheduling conflict.

7. The WTRU of claim 1, wherein the processor is configured to:
receive, from a gNB, a measurement gap configuration for data collection, wherein the measurement gap configuration is determined by the gNB based on configuration information from one or more network entities, the one or more network entities comprising at least one of the gNB, an access and mobility management function (AMF), or an operations, administration, and maintenance (OAM) function.

8. The WTRU of claim 1, wherein the processor is configured to:
determine that the measurement gap configuration is no longer needed based on an indication that AIML model training is complete; and
send, to the network, an indication that the data collection is complete.

9. The WTRU of claim 1, wherein the processor is configured to receive, from the network, an indication that the measurement gap configuration is suspended and, in response, resume regular transmission and reception according to network scheduling.

10. The WTRU of claim 1, wherein the processor is configured to temporarily suspend data collection in response to power constraints.

11. A method implemented by a wireless transmit/receive unit (WTRU), the method comprising:
receiving a data collection configuration, wherein the data collection configuration comprises an indication of measurement resources and an identifier associated with a WTRU-side or network-side artificial intelligence/machine learning (AIML) data collection;
performing data collection based on the data collection configuration;
determining that the WTRU cannot continue to collect data in accordance with the data collection configuration;
sending, to a network, an indication that the WTRU cannot continue to collect data in accordance with the data collection configuration;
receiving, from the network, an indication for a measurement gap configuration;
resuming data collection based on the data collection configuration and in accordance with the measurement gap configuration.

12. The method of claim 11, wherein the data collection configuration comprises at least one of an indication of a data reporting requirement, a measurement periodicity, or a preferred measurement gap configuration.

13. The method of claim 11, wherein the identifier associated with WTRU-side or network-side AIML data collection corresponds to data indicating at least one of network-side AIML model training conditions, a classification label for collected data, or a reference to a previously trained model.

14. The method of claim 11, further comprising determining that the WTRU cannot continue to collect data in accordance with the data collection configuration based on at least one of exceeding WTRU processing capability due to at least one of retuning time or frequency switching constraints, an invalid band combination, a measurement scheduling conflict, or conflicting configurations from multiple network entities.

15. The method of claim 11, further comprising:
determining that the WTRU cannot continue to collect data in accordance with the data collection configuration; and
requesting the measurement gap configuration from the network based on the determining that data collection cannot continue in accordance with the data collection configuration.

16. The method of claim 11, wherein the indication sent to the network comprises at least one of a reason data collection cannot continue, a preferred measurement gap configuration, or an indication of one or more configurations preventing the WTRU from resuming data collection, wherein the one or more configurations preventing the WTRU from resuming data collection comprise at least one of WTRU capability limitations, invalid band combinations, conflicting data collection configurations, or scheduling conflicts.

17. The method of claim 11, further comprising:
receiving, from a gNB, a measurement gap configuration for data collection, wherein the measurement gap configuration is determined by the gNB based on configuration information from one or more network entities, the one or more network entities comprising at least one of the gNB, an access and mobility management function (AMF), or an operations, administration, and maintenance (OAM) function.

18. The method of claim 11, further comprising:
determining that the measurement gap configuration is no longer needed based on an indication that AIML model training is complete; and
send, to the network, an indication that the data collection is complete.

19. The method of claim 11, further comprising receiving, from the network, an indication that the measurement gap configuration is suspended and, in response, resuming regular transmission and reception according to network scheduling.

20. The method of claim 11, further comprising temporarily suspending data collection in response to power constraints.
